(19) United States
(12) Patent Application Publication
(10) Pub. No.: US 2012/0187597 A1
(43) Pub. Date: Jul. 26, 2012

(54) SUBSTRATE CAPABLE OF PRODUCING 3D PATTERN HAVING COLORED DAZZLE LIGHT EFFECT, AND METHOD OF PRODUCING PATTERN AND FABRICATING FINISHED PRODUCT

(76) Inventor: KUN-MU LI, TAINAN COUNTY (TW)

(21) Appl. No.: 13/010,012

(22) Filed: Jan. 20, 2011

(51) Int. Cl. B32B 3/28; B29C 45/14; C25D 5/56

(52) U.S. Cl. 264/259; 205/50; 205/164

(57) ABSTRACT

A substrate capable of producing 3D pattern having colored dazzle light effect and a method of producing pattern and fabricating finished product are provided, in which plastic foaming sheet is selected as base material and reflection film having its surface electroplated is overlaid thereon. Then, embossing process is conducted to form concave-convex veins, and finally printing is conducted to form a print-layer thereon, so that the surface of the substrate possesses a 3D pattern having colored dazzle light effect. This substrate can be utilized in products as container, tray, eyeglass frame or watchstrap.

### BACKGROUND OF THE INVENTION

1. Field of the Invention

The present invention relates to a substrate capable of producing 3D pattern having colored dazzle light effect and a method of producing pattern and fabricating finished products, more particularly to a substrate, having 3D pattern with colored dazzle light effect, which is low in production cost and capable of maintaining pattern integrity in finished product fabrication, and is easily to integrate with finished product body.

2. Brief Description of Prior Art

Patterns formed on substrate sheet in early stage are almost accomplished directly by printing on the surface of substrate sheet. However, with the upgrade of people's living standard and technological progress, such conventional planar patterns no longer meet the demand of consumers. Thus, concerned manufacturers undertake development and research actively on how to produce 3D patterns on substrate sheet.

Currently, the technology of forming 3D patterns on substrate sheet available on the market is mainly produced by sticking an aluminum plate on a paper board, and then conducting embossing on the aluminum plate to form veins thereon, and finally printing corresponding patterns atop. However, 3D patterns formed by this method has poor 3D effect due to insufficiency in embossed depth of veins caused by small thickness of the paper board itself. Later, substrate sheet having its depth of embossed veins deepened so as to allow its 3D effect become more obvious has been developed, in which polyester terephthalate layer, aluminum layer, polyurethane layer, polyester terephthalate layer, and printed layer are provided in this order on a base material of paper board, so that the depth of veins after embossing can be deepened by the provision of the polyester terephthalate layer and polyurethane layer so as to produce better 3D effect. However, more quantity of materials and more manufacturing process have to be used in this technology, hence manufacturing cost becomes higher. Additionally, in case of fabricating finished product such as container, tray, eyeglass frame or watchstrap, the binding between the substrate and the finished product becomes very poor as the material of substrate differs from that of the finished product. Further, the pattern deformation is easily formed by the impact of high temperature during molding.

### SUMMARY OF INVENTION

In view of the above defects happened in the 3D patterns formed on conventional substrate sheet in practical implementation, the inventor of the present invention hereby proposes a novel substrate of the present invention according to his endless endeavor and based on the assistance of his abundant experience of R&D and manufacturing in relevant field.

The main object of the present invention is essentially to provide a substrate capable of producing 3D pattern having colored dazzle light effect, with low production cost and capable of maintaining pattern integrity in finished product fabrication, and easily to integrate with finished product body; and a method of producing pattern and fabricating finished product.

The object and effect of the substrate capable of producing 3D pattern having colored dazzle light effect and the method of producing pattern and fabricating finished product of the present invention can be realized by the technology described below.

Essentially, plastic foaming sheet is selected as base material and a reflection film having its surface electroplated is overlaid thereon. Then, embossing process is conducted to form concave-convex veins, and finally printing is conducted to form print-layer thereon, so that the surface of the substrate possesses a 3D pattern having colored dazzle light effect.

Furthermore, the substrate capable of producing 3D pattern having colored dazzle light effect of the present invention is conducted with integral injection overmolding with plastic material such that the plastic product has a 3D pattern with colored dazzle light effect on its surface.

The method of molding the plastic product will be described below.

The substrate having 3D pattern with colored dazzle light effect is placed within the dies for molding plastic product, and then plastic material is directly injected therein. Demoulding is conducted after the plastic material is cooled down and hardened, and the 3D pattern having colored dazzle light effect can be produced on the surface of the molded plastic product.

The above plastic product is container, tray, eyeglass frame or watchstrap.

In addition, when the plastic product such as container is made of polypropylene (PP), polypropylene foaming material can be selected as the base material of the substrate having 3D pattern with colored dazzle light effect so that the material of the plastic product is the same as that of the base material of the substrate of this invention. Hence, the binding between the substrate and the plastic product becomes much better than prior art. If the plastic product such as tray is made of acrylonitrile butadiene styrene (ABS) or polystyrene (PS), then ABS or PS foaming material can be used as the base material of the substrate of this invention. When the plastic product such as eyeglass frame adopts polycarbonate (PC) or polymethyl methacrylate (PMMA) as raw material, then PC or PMMA foaming material can be used as the base material of the substrate of this invention. If the plastic product such as watchstrap is made of ethylene vinyle acetate copolymer (EVA), then EVA foaming material can be used as the base material of the substrate of this invention.

Furthermore, when the base material of the substrate having 3D pattern with colored dazzle light effect is made of polypropylene (PP) foaming material, as the PP foaming material itself has heat insulation effect, pattern deformation during injection overmolding operation with plastic material can be avoided.

### BRIEF DESCRIPTION OF THE DRAWINGS

FIG. 1 is a schematic view showing the structure of the substrate embodying the present invention.

FIG. 2 is a manufacturing flow chart showing the structure of the substrate of the present invention.

FIG. 3 is a manufacturing flow chart showing the overmolding of the substrate of the present invention and plastic product integrally injected.

FIG. 4 is a schematic view showing the status of the integral injection overmolding of the substrate of the present invention and plastic product.

FIG. 5 is a schematic view showing the overmolding of the substrate of the present invention and plastic product integrally injected on container.

FIG. 6 is a schematic view showing the overmolding of the substrate of the present invention and plastic product integrally injected on tray.

FIG. 7 is a schematic view showing the overmolding of the substrate of the present invention and plastic product integrally injected on eyeglass frame.

FIG. 8 is a schematic view showing the overmolding of the substrate of the present invention and plastic product integrally injected on watchstrap.

### DETAILED DESCRIPTION OF PREFERRED EMBODIMENTS

The objects, the technical contents and the expected effectiveness of the present invention will become more apparent from the detailed description of the preferred embodiments in conjunction with the accompanying drawings.

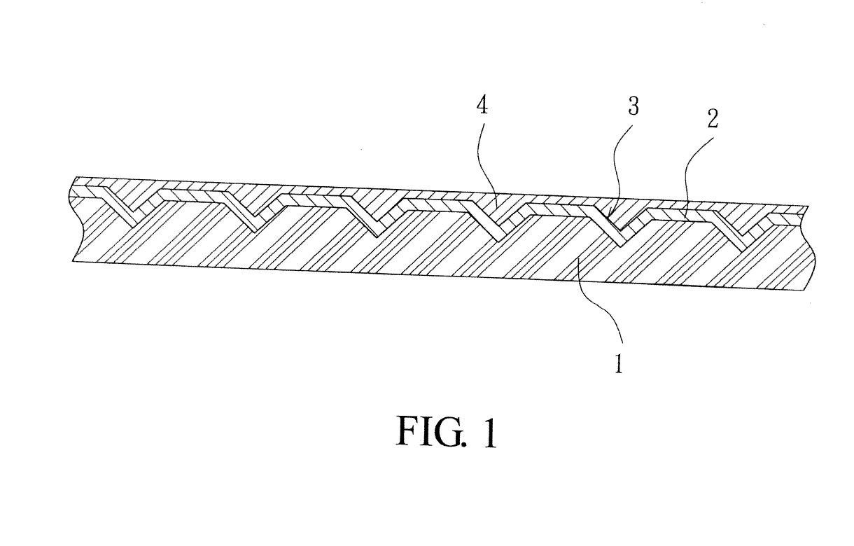

Firstly referring to FIG. 1, the substrate having 3D pattern with colored dazzle light effect essentially has a base material (1) and a reflection film (2) overlaid thereon. Then, embossing is conducted on the base material (1) and reflection film (2), which is integrally combined together, to form concave-convex veins (3), and finally printing is conducted to form a print-layer (4) thereon. The base material (1) can adopt plastic foaming material, while the reflection film (2) can be a film made of polyethylene terephthalate (PET) material having its surface electroplated.

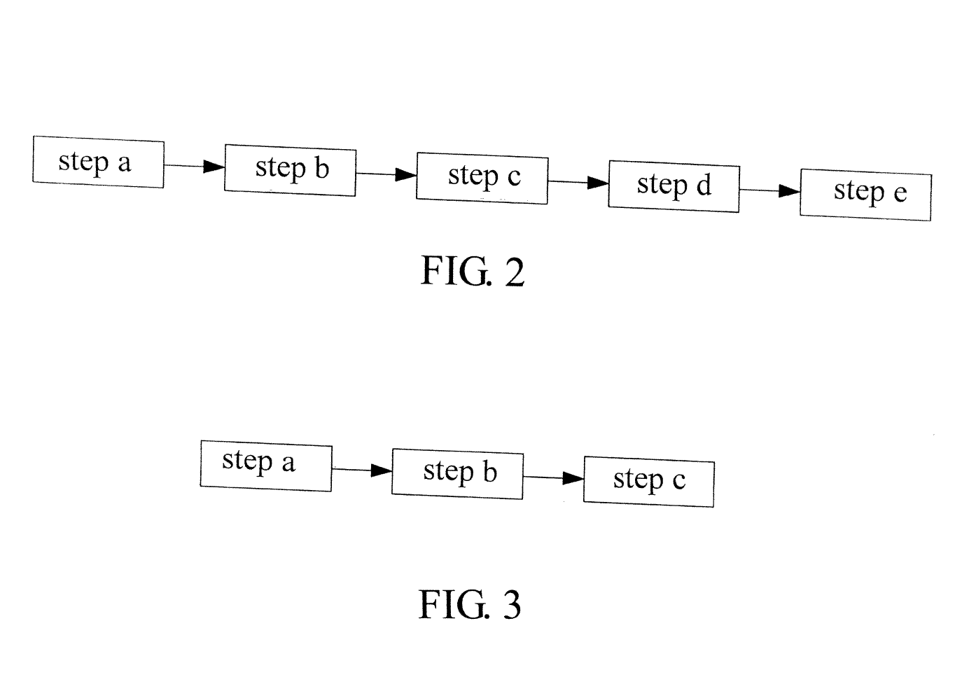

Further referring to a manufacturing flow chart of forming the substrate in FIG. 2, the forming steps of the substrate of the present invention comprises the following steps of:
(a) choosing plastic foaming material as the base material (1):
(b) conducting electroplating on the surface of the polyethylene terephthalate (PET) film so as to form a reflection film (2);
(c) overlaying the reflection film (2) on the base material (1);
(d) conducting embossing on the base material (1) and the reflection film (2) integrally formed together, so as to form concave-convex veins (3) thereon:
(e) printing patterns so as to form a print-layer thereon.

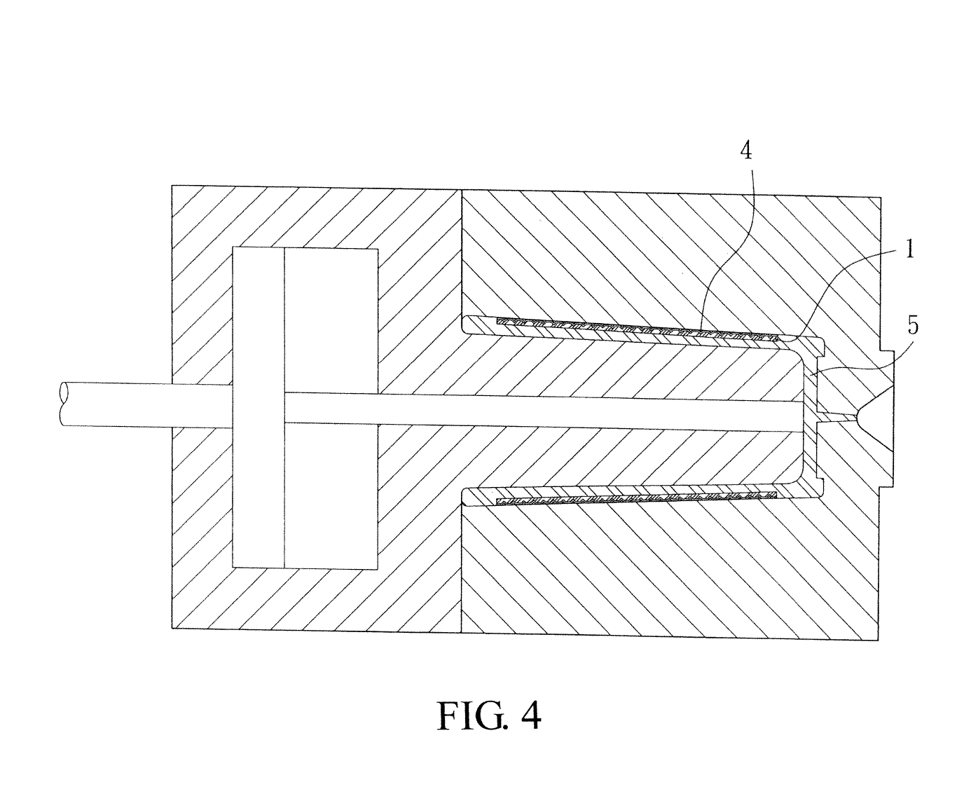

As shown in FIGS. 3 and 4, the substrate capable of producing a 3D pattern having colored dazzle light effect and plastic material are conducted with integral injection overmolding so as to allow the plastic product (5) to have a 3D pattern with colored dazzle light affixed on its surface, the manufacturing flow chart of the plastic product (5) comprises the following steps of:
(a) trimming the substrate capable of producing a 3D pattern having colored dazzle light effect into a shape conforming to that of the plastic product (5) to be molded;
(b) placing the substrate trimmed according to item (a) in the dies for molding the plastic product (5);
(c) injecting the plastic material into the dies so as to integrally overmold the substrate capable of producing a 3D pattern having colored dazzle light effect, so that the plastic product (5) having 3D pattern with colored dazzle light effect on its surface is formed.

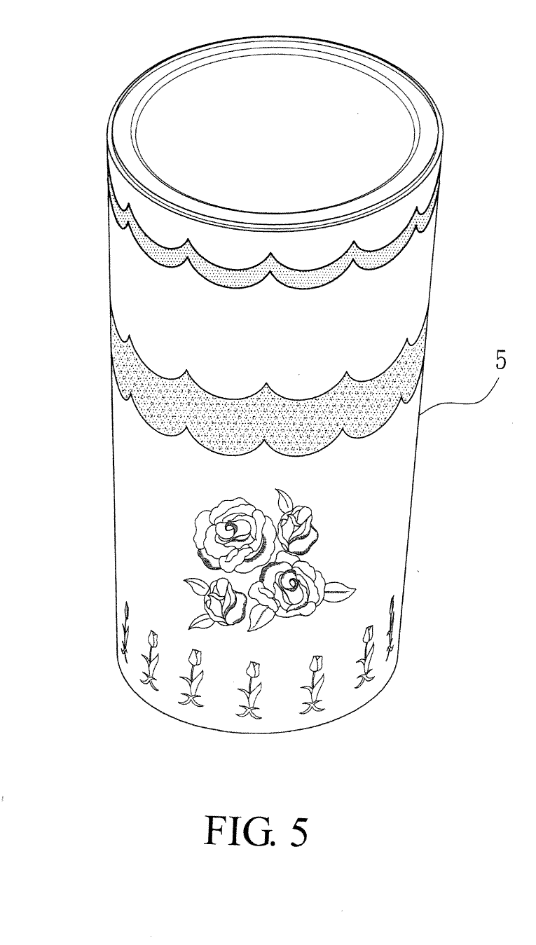

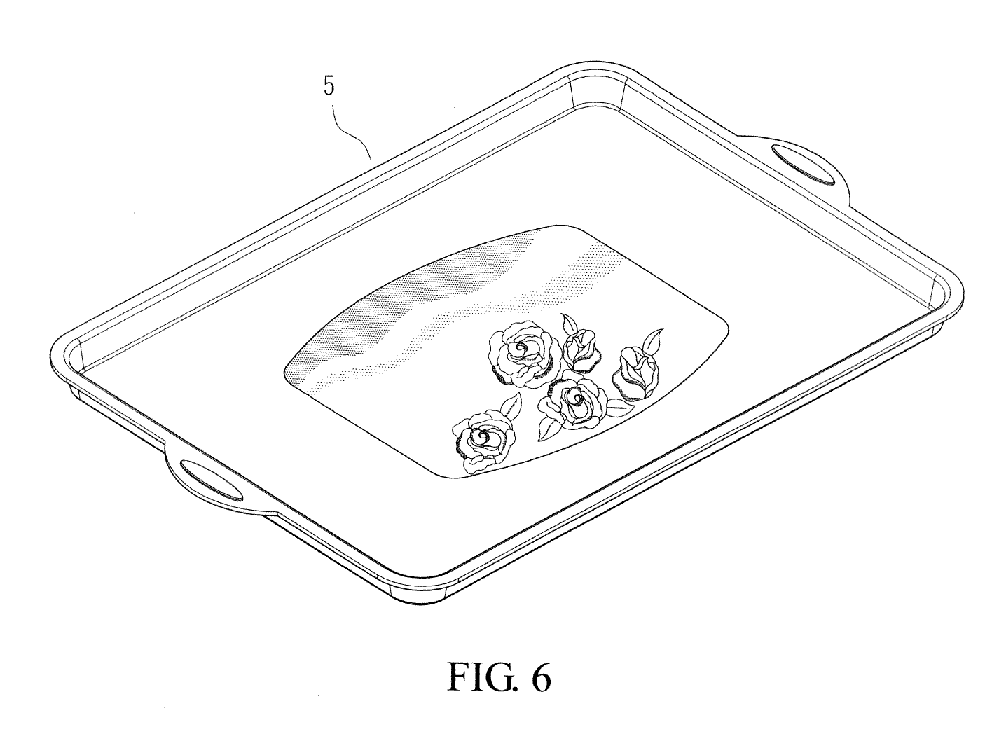

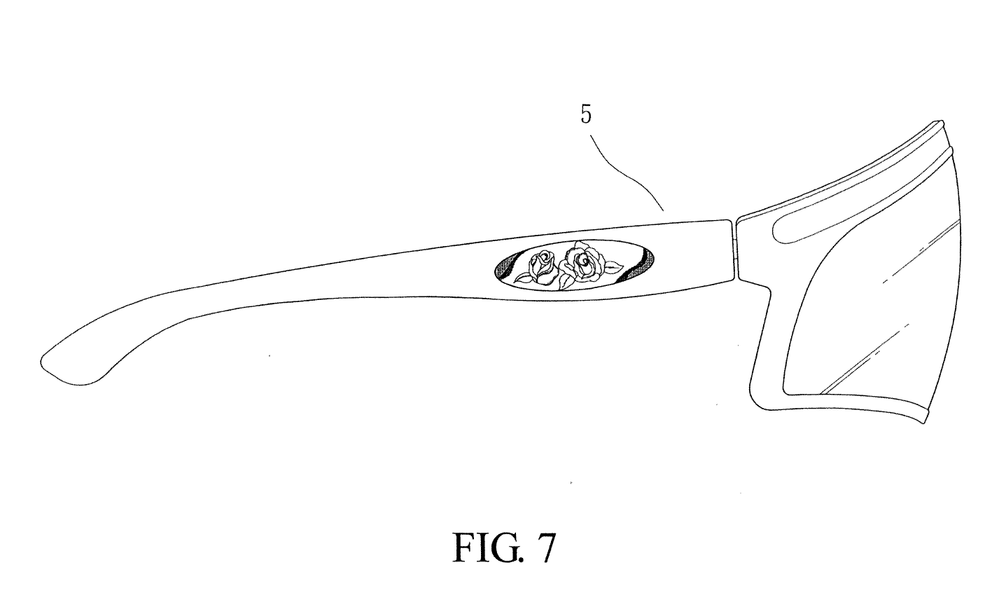

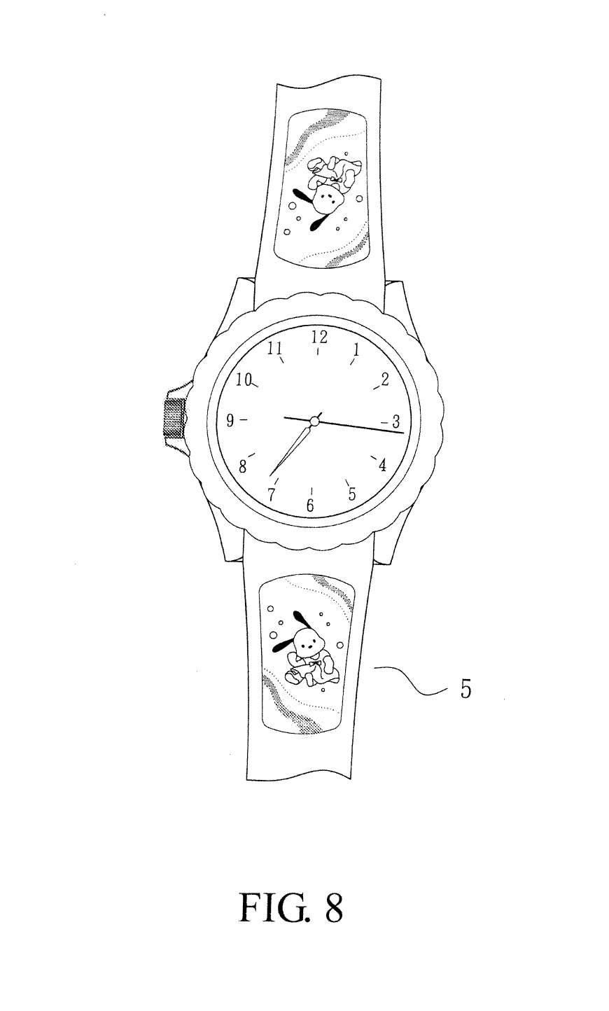

The plastic foaming material for the above base material can be selected from the group containing polypropylene (PP), acrylonitrile butadiene styrene (ABS), polystyrene (PS), polycarbonate (PC), polymethyl methacrylate (PMMA) or ethylene vinyle acetate copolymer (EVA), and the plastic material for the plastic product can be selected in such a manner as to correspond to the plastic foaming material selected for the base material. Further, the plastic product can be container, tray, eyeglass frame or watchstrap, as shown in FIGS. 5 to 8.

When the plastic product is container and is made of polypropylene (PP), then PP foaming material can be selected as the base material; If the plastic product is tray and is made of acrylonitrile butadiene styrene (ABS) or polystyrene (PS), then ABS or PS foaming material can be used as the base material; when the plastic product is an eyeglass frame and adopts polycarbonate (PC) or polymethyl methacrylate (PMMA) as raw material, then PC or PMMA foaming material can be used as the base material; if the plastic product is watchstrap and is made of ethylene vinyle acetate copolymer (EVA), then EVA foaming material can be used as the base material.

Based on foregoing, apparently this invention at least has advantages set forth below.

1. As the base material of the present invention adopts plastic foaming material having a certain thickness itself, convex and concave veins having deeper depth can be embossed on the substrate so that the pattern on the surface of the substrate has better 3D colored dazzle light effect.

2. As less material and steps of molding is adopted in the present invention, manufacturing cost can be reduced.

3. As the plastic material adopted in plastic product to be molded is the same as the plastic foaming material used in the base material, better binding between the substrate of the present invention and the plastic product can be achieved.

4. When polypropylene (PP) foaming material is adopted as the base material of the substrate of this invention, as the PP foaming material itself has heat insulation effect, pattern deformation during injection overmolding operation with plastic material can be avoided. Moreover, yield rate of the plastic product can be raised.

What is claimed is:

1. A substrate capable of producing 3D pattern having colored dazzle light effect, wherein it comprises:
a base material (1) made of plastic foaming material;
a reflection film overlaid on said base material, which is a film made of polyethylene terephthalate (PET) and is conducted with electroplating on its surface; and
concave-convex veins formed by conducting embossing on said base material and said reflection film integrally combined together, and then a print-layer formed by print process.

2. A substrate capable of producing pattern having 3D colored dazzle light effect as claimed in claim 1, wherein said plastic foaming material chosen for said base material is any one selected from the group containing polypropylene (PP), acrylonitrile butadiene styrene (ABS), polystyrene (PS), polycarbonate (PC), polymethyl methacrylate (PMMA), and ethylene vinyle acetate copolymer (EVA).

3. A method of manufacturing substrate capable of producing 3D pattern having colored dazzle light effect, comprising the following steps of:
(a) choosing plastic foaming material as the base material;
(b) conducting electroplating on the surface of the polyethylene terephthalate (PET) film so as to form a reflection film;
(c) overlaying said reflection film on said base material;
(d) conducting embossing on said base material and said reflection film which are integrally combined together, so as to form concave-convex veins thereon;
(e) printing pattern so as to form print-layer thereon.

4. A method of manufacturing substrate capable of producing pattern having 3D colored dazzle light effect as claimed in claim 3, wherein the plastic foaming material chosen for said base material is any one selected from the group containing polypropylene (PP), acrylonitrile butadiene styrene (ABS), polystyrene (PS), polycarbonate (PC), polymethyl methacrylate (PMMA), and ethylene vinyle acetate copolymer (EVA).

5. A method of fabricating substrate capable of producing 3D pattern having colored dazzle light effect into finished product, comprising steps of:
(a) trimming the substrate capable of producing a 3D pattern having colored dazzle light effect as claimed in claim 1 into a predetermined shape;
(b) placing said substrate trimmed according to item (a) in the dies for molding plastic product;
(c) injecting plastic material into the dies so as to integrally overmold said substrate capable of producing pattern having 3D colored dazzle light effect, so that the a plastic product having 3D pattern with colored dazzle light effect on its surface is formed.

6. A method of fabricating substrate capable of producing 3D pattern having colored dazzle light effect into finished product as claimed in claim 5, wherein polypropylene (PP) is selected as the material for making said plastic product and PP foaming material is used as the base material of said substrate.

7. A method of fabricating substrate capable of producing 3D pattern having colored dazzle light effect into finished product as claimed in claim 6, wherein said plastic product is container.

8. A method of fabricating substrate capable of producing 3D pattern having colored dazzle light effect into finished product as claimed in claim 5, wherein the material for making said plastic product is acrylonitrile butadiene styrene (ABS) and the base material of said substrate is ABS foaming material.

9. A method of fabricating substrate capable of producing 3D pattern having colored dazzle light effect into finished product as claimed in claim 8, wherein said plastic product is tray.

10. A method of fabricating substrate capable of producing pattern having 3D colored dazzle light effect into finished product as claimed in claim 5, wherein polystyrene (PS) is selected as the material for making said plastic product, and PS foaming material the base material of said substrate.

11. A method of fabricating substrate capable of producing pattern having 3D colored dazzle light effect into finished product as claimed in claim 10, wherein said plastic product is tray.

12. A method of fabricating substrate capable of producing pattern having 3D colored dazzle light effect into finished product as claimed in claim 5, wherein polycarbonate (PC) is selected as the material for making said plastic product, and PC foaming material the base material of said substrate.

13. A method of fabricating substrate capable of producing pattern having 3D colored dazzle light effect into finished product as claimed in claim 12, wherein said plastic product is eyeglass frame.

14. A method of fabricating substrate capable of producing pattern having 3D colored dazzle light effect into finished product as claimed in claim 5, wherein polymethyl methacrylate (PMMA) is selected as the material for making said plastic product, and PMMA foaming material the base material of said substrate.

15. A method of fabricating substrate capable of producing pattern having 3D colored dazzle light effect into finished product as claimed in claim 14, wherein said plastic product is eyeglass frame.

16. A method of fabricating substrate capable of producing pattern having 3D colored dazzle light effect into finished product as claimed in claim 5, wherein ethylene vinyle acetate copolymer (EVA) is selected as the material for making said plastic product, and EVA foaming material the base material of said substrate.

17. A method of fabricating substrate capable of producing pattern having 3D colored dazzle light effect into finished product as claimed in claim 16, wherein said plastic product is watchstrap.
